(19) United States
(12) Patent Application Publication
(10) Pub. No.: US 2018/0142722 A1
(43) Pub. Date: May 24, 2018

(54) Tamper proof deadbolt lock screw

(71) Applicant: Benjamin Bérubé, Quebec (CA)

(72) Inventor: Benjamin Bérubé, Quebec (CA)

(21) Appl. No.: 15/361,032

(22) Filed: Nov. 24, 2016

(51) Int. Cl. F16B 41/00

(52) U.S. Cl. CPC F16B 41/005

(57) ABSTRACT

A tamper proof deadbolt lock screw comprising a cylindrical body having a first end and a second end, wherein the second end includes a hole having a first diameter, wherein the hole is drilled along an axis of the cylindrical body; and a tamper prevention element positioned in the hole.

### CROSS-REFERENCE TO RELATED APPLICATIONS

The present application claims priority to U.S. Provisional Patent Application Ser. No. 62/386,434, filed on Dec. 2, 2015 entitled “Lock screw test drilling”, the disclosure of which is hereby incorporated in its entirety at least by reference.

### BACKGROUND OF THE INVENTION

### 1. Field of the Invention

The present invention relates generally to locking mechanisms such as deadbolts, but more particularly to a tamper proof deadbolt lock screw.

### 2. Description of Related Art

Deadbolt lock screws are prone to drilling and unscrewing, allowing burglars to break the lock and disengage the locking mechanism. FIG. 5 shows an example of a prior art using tempered steel balls (128) that reduce the possibility of drilling or unscrewing, but the installation of these balls (128) is problematic. The balls (128), which are placed in front of the screws (100), tend to fall off during installation, maintenance, or adjustments, and can be easily removed by a hook or magnet, when the outside of the lock is perforated, since nothing holds the balls (128) into position. In such situations, a tamper proof lock screw could avoid this kind of dis-assembly, and keep the lock safe and functional.

### BRIEF SUMMARY OF THE INVENTION

In one embodiment of the present invention a tamper proof deadbolt lock screw is provided, comprising a cylindrical body having a first end and a second end, wherein the second end includes a hole having a first diameter, wherein the hole is drilled along an axis of the cylindrical body; and a tamper prevention element positioned in the hole.

In one embodiment, a groove is provided, the groove having a second diameter, wherein the groove is machined adjacent to the hole along the axis of the cylindrical body. In another embodiment, the tamper prevention element is a nipple comprising a cap, a split stem, and a pair of footings having a third diameter, wherein the nipple is constructed from steel. In one embodiment, the third diameter is larger than the first diameter, and the second diameter is larger than the third diameter. In yet another embodiment, the nipple is inserted into the hole such that the split stem and pair of footings are compressed decreasing the third diameter allowing the pair of footings to pass through the hole into the groove, when the split stem and pair of footings are decompressed the nipple is in a locked position. In one embodiment, the nipple can rotate freely such that drilling tools and repeated impacts cannot unscrew the lock screw. In another embodiment, the nipple comprises an ultra-polished surface preventing drilling tools from gaining traction on the surface.

In one embodiment, the second end includes a rim portion. In another embodiment, the tamper prevention element is a ball, wherein the ball is constructed from a hard metal. In one embodiment, the ball is secured in position when pressure is applied to the rim portion such that the rim portion partially folds back over the ball preventing the ball from being pulled and/or dislodged from the hole. In one embodiment, the ball can rotate freely such that drilling tools and repeated impacts cannot unscrew the lock screw. In yet another embodiment, the ball comprises an ultra-polished surface preventing drilling tools from gaining traction on the surface.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIGS. 1A-C illustrate exploded, isometric, and detail views of a tamper proof deadbolt lock screw in accordance with an embodiment of the present invention.

FIGS. 2A-B illustrate exploded and isometric views of a tamper proof deadbolt lock screw in accordance with an embodiment of the present invention.

FIGS. 3A-C illustrate side views of components of a tamper proof deadbolt lock screw in accordance with various embodiments of the present invention.

FIGS. 4A-B illustrate front and side views of tamper proof deadbolt lock screws installed in a locking system in accordance with an embodiment of the present invention.

FIG. 5 illustrates a side view of a deadbolt of the prior art using tempered steel balls.

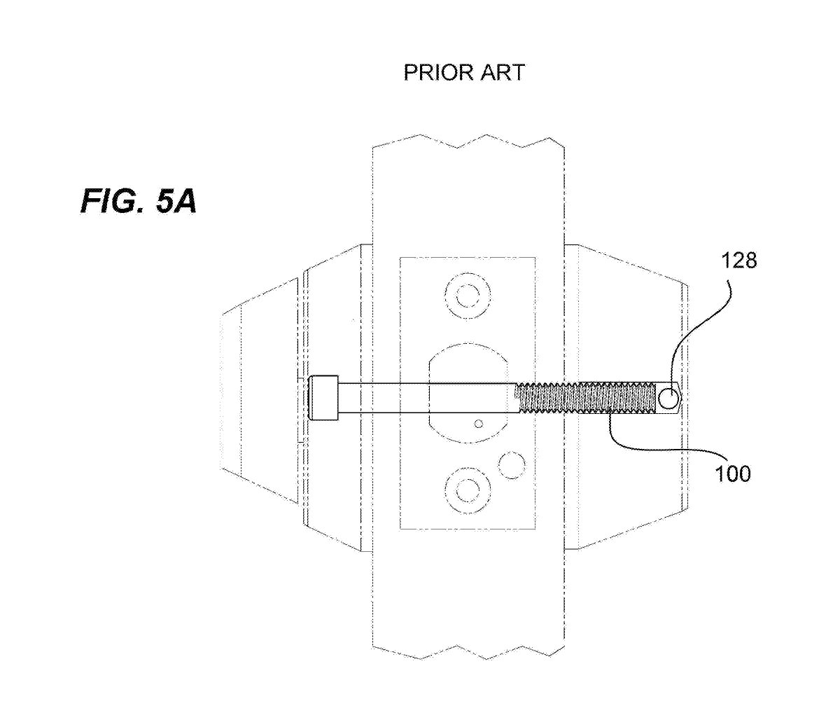

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a tamper proof deadbolt lock screw.

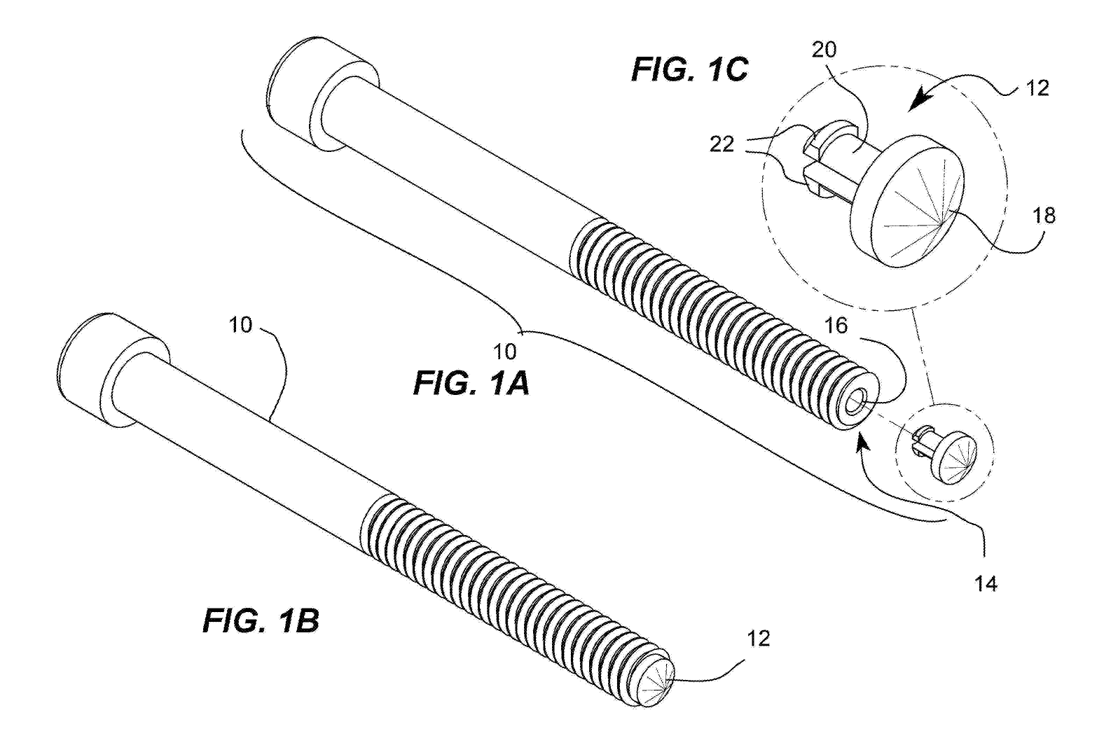

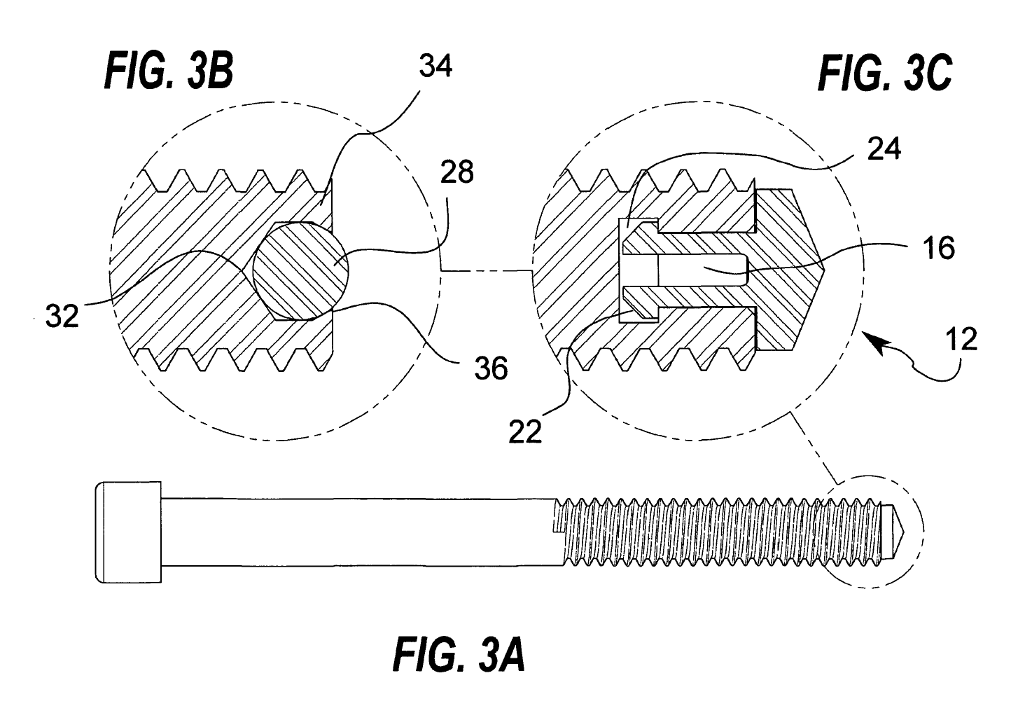

FIGS. 1A-C illustrate exploded, isometric, and detail views of a tamper proof deadbolt lock screw 10 in accordance with an embodiment of the present invention. Referring now to FIGS. 1A-C, the tamper proof deadbolt lock screw is illustrated. The tamper proof deadbolt lock screw comprises a hole 16 having a first diameter located at a tip portion 14 of the lock screw. The hole is drilled in the tip portion along the axis of the lock screw. In one embodiment, a groove 24 (FIG. 3C) having a second diameter is machined at a bottom portion of the hole. In one embodiment, a nipple 12 is inserted into the hole of the lock screw. The nipple is constructed of a strong alloy, such as steel. The nipple comprises a cap 18, a split stem 20, and footings 22 having a third diameter. The third diameter of the footings is larger than the first diameter of the hole, but smaller than the second diameter of the groove.

In operation, the nipple is inserted into the hole by squeezing the split stem allowing the footings to pass through the first diameter. Next, at the bottom portion of the hole, the split stem is released allowing the footings to spread out into the second diameter of the groove. Specifically, by squeezing the split stem, the footings touch temporally making the third diameter smaller than the first diameter allowing the footings to pass through the hole, and then when the split stem is released the footings spread out into the groove returning the third diameter to its original size. Once the footings are situated in the groove, the nipple is prevented from exiting the hole. It is a particular object of the present invention that the nipple can freely rotate while securely positioned in the tip portion while prevented from being withdrawn. Thus, drilling tools and repeated impacts of milling tools or other methods cannot unscrew the lock screw since these actions simply make the nipple rotate freely. The nipple is constructed with an ultra-polished surface finish preventing tampering methods, such as drilling tools from gaining traction on the surface of the nipple, as these tools slide of the surface failing to grasp the nipple.

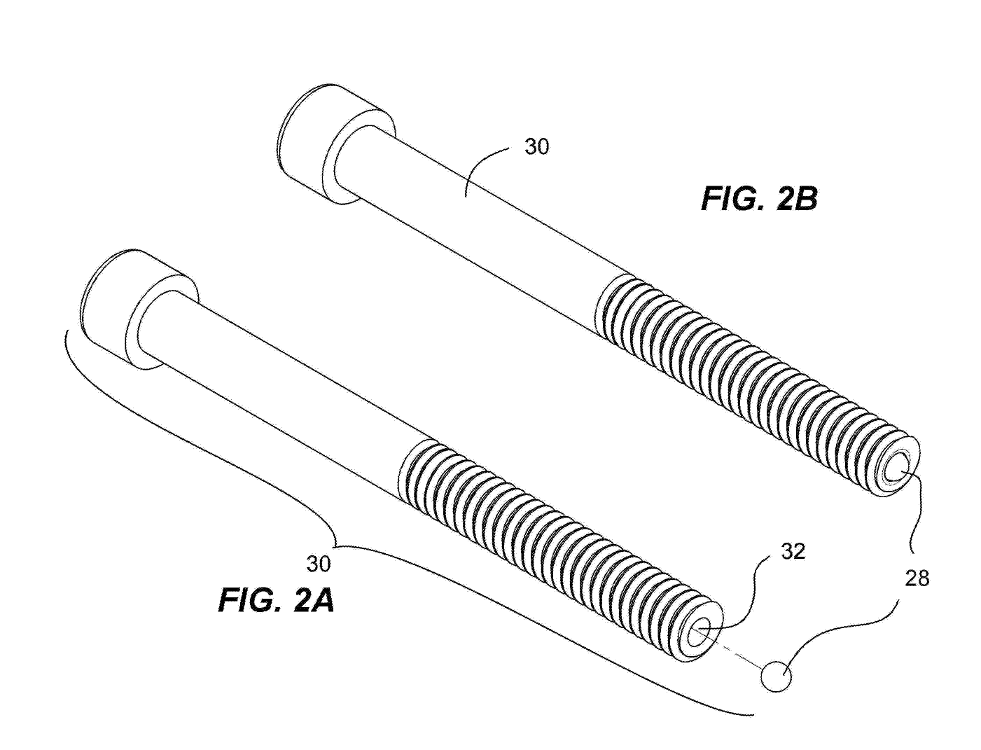

FIGS. 2A-B illustrate exploded and isometric views of a tamper proof deadbolt lock screw 30 in accordance with an embodiment of the present invention. Now referring to FIGS. 2A-B, in one embodiment a ball 28 is inserted into a hole 32 located in a tip portion 34 of the lock screw. In this embodiment, the tip portion and hole of the lock screw are have different features then previously described above. In this embodiment, the tip portion comprises a rim portion 34 (FIG. 3B), wherein pressure is applied to the rim portion in such a way so it partially folds back over the ball 36 (FIG. 3B) which prevents the ball from being pulled or dislodged out of the hole once inserted. It is important that the depth of the hole is deep enough to allow the creation of the rim portion. Although the ball is secured in the hole of the tip portion, it may still freely rotate allowing the lock screw to function similarly to the previous disclosed embodiment featuring the nipple. In one embodiment, the ball is constructed of a hard material, such as metal with an ultra-polished surface finish. Drilling tools and repeated impacts of milling tools or other bits attached to a drill in “hammer” mode cannot unscrew the lock because such actions make the ball rotate freely. The ball's spherical shape prevents drilling tools from gaining traction on the surface of the ball, as these tools slide of the surface failing to grasp the ball.

FIGS. 3A-C illustrate side views of components of a tamper proof deadbolt lock screw in accordance with various embodiments of the present invention. Referring now to FIGS. 3A-C, the previously disclosed embodiments are illustrated adjacent to each other. FIG. 3B illustrates the ball 28 inserted into hole 32, with the rim portion 34 securing the ball in position as previously described. FIG. 3C illustrates the nipple 12 inserted into hole 16, and secured via the footings 22 positioned into groove 24 as previously described.

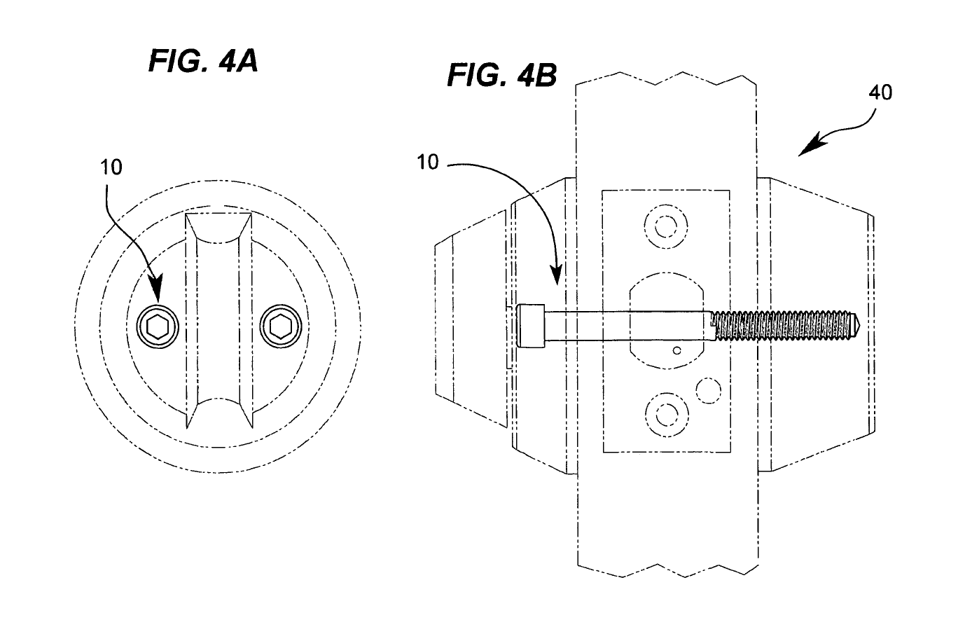

FIGS. 4A-B illustrate front and side views of tamper proof deadbolt lock screws 10 installed in a locking system 40 in accordance with an embodiment of the present invention. Referring now to FIGS. 4A-B, the tamper proof lock screws are installed in a deadbolt locking system 40 on a door 42 as well known in the art. The length of the lock screws are dependent on the specific locking system and door thickness as well known in the art.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A combination of a deadbolt lock and a screw having a temper prevention element comprising:
the screw has a first end and a second end, wherein the second end includes a hole having a first diameter, wherein the hole is drilled along an axis of the screw; and
the tamper prevention element is positioned in the hole.

2. The combination of claim 1, further comprising a groove having a second diameter, wherein the groove is machined adjacent to the hole along the axis of the cylindrical body.

3. The combination of claim 2, wherein the tamper prevention element is a nipple comprising a cap, a split stem, and a pair of footings having a third diameter, wherein the nipple is constructed from steel.

4. The combination of claim 3, wherein the third diameter is larger than the first diameter, and the second diameter is larger than the third diameter.

5. The combination of claim 4, wherein the nipple is inserted into the hole such that the split stem and pair of footings are compressed decreasing the third diameter allowing the pair of footings to pass through the hole into the groove, when the split stem and pair of footings are decompressed the nipple is in a locked position.

6. The combination of claim 5, wherein the nipple can rotate freely such that drilling tools and repeated impacts cannot unscrew the lock screw.

7. The combination of claim 5, wherein the nipple comprises an ultra-polished surface preventing drilling tools from gaining traction on the surface.

8. The combination of claim 1, wherein the second end includes a rim portion.

9. The combination of claim 8, wherein the tamper prevention element is a ball, wherein the ball is constructed from a hard metal.

10. The combination of claim 9, wherein the ball is secured in position when pressure is applied to the rim portion such that the rim portion partially folds back over the ball preventing the ball from being pulled and/or dislodged from the hole.

11. The combination of claim 10, wherein the ball can rotate freely such that drilling tools and repeated impacts cannot unscrew the lock screw.

12. The combination of claim 10, wherein the ball comprises an ultra-polished surface preventing drilling tools from gaining traction on the surface.
